(19) United States
(12) Patent Application Publication
(10) Pub. No.: US 2014/0199065 A1
(43) Pub. Date: Jul. 17, 2014

(54) MULTIMODE MULTIPLEXING

(71) Applicant: HEWLETT-PACKARD DEVELOPMENT COMPANY, LP., Houston, TX (US)

(72) Inventors: Alexandre M. Bratkovski, Palo Alto, CA (US); Jacob Khurgin, Pikesville, MD (US); Wayne Victor Sorin, Palo Alto, CA (US); Michael Renne Ty Tan, Palo Alto, CA (US)

(73) Assignee: HEWLETT-PACKARD DEVELOPMENT COMPANY, L.P., Houston, TX (US)

(21) Appl. No.: 13/742,198

(22) Filed: Jan. 15, 2013

(51) Int. Cl. H04J 14/04

(52) U.S. Cl. CPC H04J 14/04
USPC 398/44

(57) ABSTRACT

A system includes a transmitter to multiplex a plurality of modulated optical signals and an unmodulated optical signal and to transmit the plurality of modulated optical signals and the unmodulated optical signal along a transmission path. The system also includes a receiver to de-multiplex each of the plurality of modulated optical signals and the unmodulated optical signal and to demodulate each of the plurality of modulated optical signals with the unmodulated optical signal to coherently detect a modulating signal from each of the plurality of modulated optical signals.

### BACKGROUND

Transmitting information via an optical domain has become the mainstay of today's data communications primarily due to a potentially large bandwidth extending over a few TeraHz. Accessing this wide bandwidth places demands on the devices and components used in such communications. Some optical communications schemes can require sophisticated optical components such as gratings, filters, and lasers applied over a number of individual channels which can increase the cost of the systems. Another scheme relies on advanced modulation formats, although such techniques can place even more design constraints at the receiving end of the respective channels which can further add cost to the system.

### BRIEF DESCRIPTION OF THE DRAWINGS

For a more complete understanding of examples of the present invention, reference is now made to the following descriptions taken in connection with the accompanying drawings in which:

FIG. 1 illustrates an example system that facilitates optical data transmission via spatial multiplexing of combined optical signals;

FIG. 2 illustrates an example transceiver system that facilitates optical data transmission and reception via spatial multiplexing of combined optical signals;

FIG. 3 illustrates example Y-junction couplers that launch different propagation modes for optical signals;

FIG. 4 illustrates an example optical transmitter system utilizing a Y-junction coupler to launch different propagation modes into a multimode waveguide;

FIG. 5 illustrates an example optical transmitter and receiver system utilizing a Y-junction coupler to launch different propagation modes into a multimode waveguide for spatially multiplexed transmission and a multimode waveguide and Y-junction coupler for reception of multiplexed optical signals;

FIG. 6 illustrates a top view and a side view of a cascaded set of Y-junction couplers for generating spatially multiplexed optical signals, according to an example;

FIGS. 7A-7D illustrate example coupling with respect to a cascaded set of Y-junction couplers for generating spatially multiplexed optical signals;

FIG. 7E illustrates a perspective view of an example cascaded set of Y-junction couplers for generating spatially multiplexed optical signals;

FIG. 8 illustrates an alternative configuration for a cascaded set of Y-junction couplers for generating and receiving spatially multiplexed optical signals, according to an example;

FIG. 9 illustrates an example flowchart of example processes that may be performed for generating and receiving spatially multiplexed optical signals.

FIG. 10 illustrates an example configuration for a cascaded set of Y-junction couplers for generating and receiving spatially multiplexed optical signals that are coherently mixed with an unmodulated signal;

FIG. 11 illustrates an example 16 QAM constellation for a modulated optical signal in accordance with various examples;

FIG. 12 illustrates an example modulator potion of a transmitter for producing modulated optical signals in accordance with various examples;

FIG. 13 illustrates a coherent receiver for coherent detection in accordance with various examples;

FIG. 14A illustrates a rotated 16 QAM constellation for a modulated optical signal in accordance with various examples;

FIG. 14B illustrates a corrected 16 QAM constellation for the modulated optical signal of FIG. 14A;

FIG. 15 illustrates example processes performed for receiving a spatially multiplexed optical signal and performing coherent detection in accordance with various examples; and

FIG. 16 illustrates a receiver for receiving a spatially multiplexed optical signal and performing coherent detection in accordance with various examples.

### DETAILED DESCRIPTION

Spatially multiplexed optical transmission systems and methods are provided where modulated optical signals are combined and launched along a data transmission path to increase information bandwidth while mitigating system costs. Information bandwidth can be increased since parallel optical input signals can be combined and transmitted in such a manner as to mitigate interference between the signals, yet enable transmission of the signals along a reduced subset of signal paths. Y-junction optical couplers can be employed to combine multiple modulated optical input signals. Narrow and wide input paths to the Y-junction couplers can be utilized to enable different modes of propagation for the modulated signals. Combined output from the Y-junction coupler (or couplers) can be applied to a multimode waveguide which, in turn, launches multiple propagating transmission signals that are orthogonal to each other and thus can travel along a shared transmission path while not causing interference between the signals. Such orthogonal propagation provides spatial multiplexing for different communications signals along the transmission path. By spatially multiplexing optical signals on to a shared transmission path, receiving components for the multiplexed optical signals can be simplified, thereby reducing system costs. In accordance with various examples, the spatially multiplexed optical transmission systems and methods rely on an unmodulated signal instead of a local oscillator to support advanced coherent modulation formats.

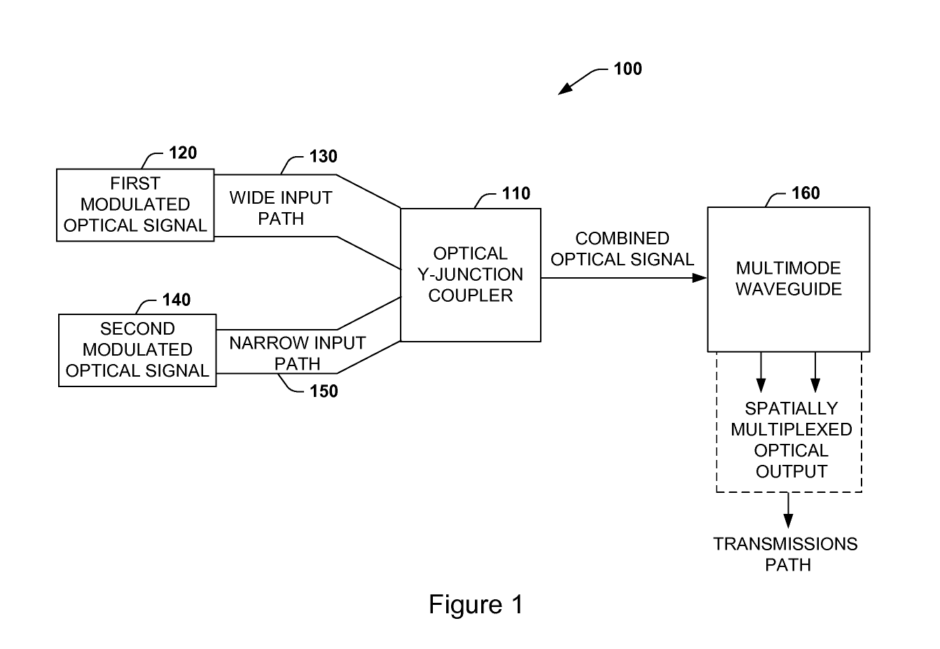

FIG. 1 illustrates an example of a system 100 that facilitates optical data transmission via spatial multiplexing of combined optical signals. The system 100 includes an optical Y-junction coupler 110 that receives a first modulated optical signal 120 on a wide input path 130 of the optical Y-junction coupler 110. The optical Y-junction coupler 110 also receives a second modulated optical signal 140 on a narrow input path 150 of the optical Y-junction coupler 110. As used herein, the terms “narrow” and “wide” may refer to differing waveguide dimensions of the Y-junction coupler 110. That is, the narrow input path 150 may refer to a waveguide width dimension that is smaller than the waveguide width dimension of the wide input path 130. The optical Y-junction coupler 110 generates a combined optical signal from modulated optical signals (that may include data that is, e.g., encoded, encrypted, compressed, or otherwise varied/modified that are received on the wide input path 130 and the narrow input path 150).

The system 100 further includes a multimode waveguide 160 that may receive the combined optical signal that is output from the optical Y-junction coupler 110. The multimode waveguide 160 may propagate a spatially multiplexed optical output signal along a transmission path (e.g., multimode multiplexed channels may be generated). The spatially multiplexed optical output generated on the transmission path may be utilized in/for various applications. For example, the transmission path may be utilized in an optical communications bus, in an optical backplane, or as a signal path within a light processor, for example, that employs optical signals for data processing, communications, or instruction execution. In one example, the optical backplane can include a planar waveguide or an optical fiber. The planar waveguide or optical fiber can be constructed using various materials such as glass or polymer, for example.

In one example, the optical Y-junction coupler 110 can be employed to combine multiple modulated optical signals received from the wide input path 130 and the narrow input path 150. In another example, multiple Y-junction couplers can be cascaded and multiplexed to increase system data throughput as illustrated and described in greater detail below. The narrow input path 150 and wide input path 130 to the Y-junction coupler 110 can be utilized to enable different modes of propagation for the modulated signals 120 and 140. The combined optical signal output from the Y-junction coupler 110 (or couplers) can be applied to the multimode waveguide 160. In turn, the multimode waveguide 160 launches multiple propagating transmission signals that are orthogonal to each other, and thus can travel along the transmission path without causing interference therebetween. Such orthogonal propagation provides spatial multiplexing for different communications signals along the transmission path. By spatially multiplexing optical signals onto the transmission path, receiving components/modules for the multiplexed optical signals can be simplified and thereby reduce system costs as previously alluded to.

Various modulation techniques can be employed to generate the first modulated signal 120 and the second modulated signal 140. Thus, coherent space division-multiplexing (SDM), described herein, provides another dimension to multiplexing optical signals and can be combined with other multiplexing methods in order to increase the effective bit rate along the transmission path. In one example, on-off keying (OOK) modulation can be utilized for the multimode multiplexed channels generated at the output of the multimode waveguide 160. If higher bandwidth is desired, one or more of the input channels can be modulated using different formats—for example frequency-shift keying (FSK), or one of the coherent formats, such as quadrature phase shift keying (QPSK), for example. In another example, a pulse amplitude modulation (PAM) method can be employed for the modulation techniques. In accordance with various examples, the system 100 is able to utilize different multimode multiplexed channels that can also use different modulation formats within the same (or similar) frequency band.

Further, one or more of the multimode multiplexed channels may also be coarse wavelength division multiplexed (CWDM), for example, provided the applicable wavelengths are not substantially too close to each other (e.g., 1300 nm and 1350 nm). CWDM signals can follow the same path and end up at the same output of a receiver, where the CWDM signals can be subsequently de-multiplexed using a coarse filter. This implies that the capacity of the transmission path can be increased by implementing additional multiplexing in each multimode multiplexed channel without changing the core of the system 100.

The modulation methods described herein, and applied to the wide input path 130 and the narrow input path 150, can include lasers, such as electrically modulated vertical cavity surface emitting lasers (VCSELs) with OOK or Frequency Division Multiplexing (FDM), for example. Other types of lasers that can be coupled to the respective inputs of the Y-junction coupler 110 can include a Fabry-Perot laser or a distributed feedback laser, for example. An external Mach-Zehnder interferometer (MZI) modulator may also be employed for generating modulated optical signals.

Further, different components/modules of the system 100 are illustrated and described as performing different functions. However, the functions of the described components/modules may be performed by different components, and/or the functionality of several components/modules can be combined and executed on a single component.

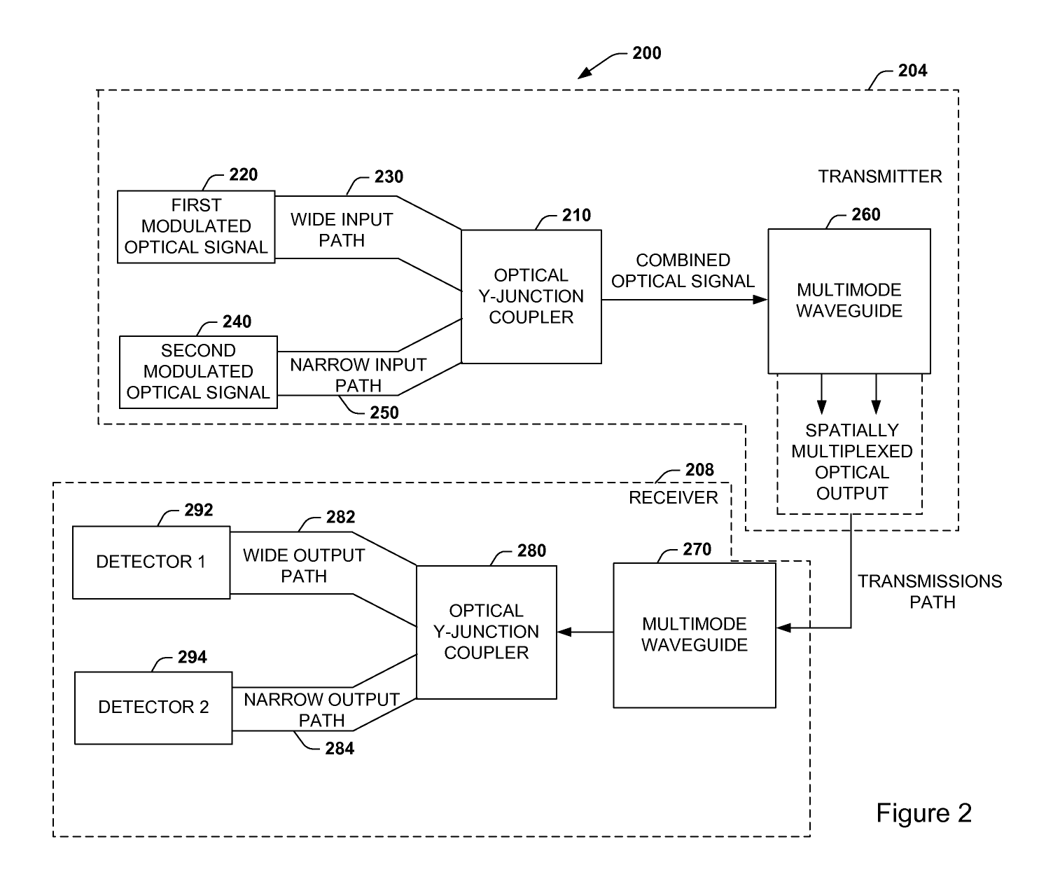

FIG. 2 illustrates an example of a transceiver system 200 that facilitates optical data transmission and reception via spatial multiplexing of combined optical signals. The system 200 can include a transmitter 204 (similar to that illustrated in FIG. 1) that generates a spatially multiplexed optical output that is received by a receiver 208. The transmitter 204 includes an optical Y-junction coupler 210 that receives a first modulated optical signal 220 on a wide input path/waveguide node 230 of the optical Y-junction coupler 210, and receives a second modulated optical signal 240 on a narrow input path/waveguide node 250 of the optical Y-junction coupler 210. The optical Y-junction coupler 210 generates a combined optical signal from modulated signals received on the wide input path/waveguide node 230 and the narrow input path/waveguide node 250 which can include modulated data (as described above). A multimode waveguide 260 receives the combined optical signal from the optical Y-junction coupler 210, and propagates a spatially multiplexed optical output signal along a transmission path that is operatively coupled to the receiver 208 (e.g., via optical fiber).

The receiver 208 relies on similar optical principals as those utilized by the transmitter 204 to process the spatially multiplexed optical output received from the transmitter 204. Accordingly, a multimode waveguide 270 receives the spatially multiplexed optical output from the transmitter 204, and provides a combined optical waveform to the input of a Y-junction coupler 280 which is operated in reverse fashion from the optical Y-junction coupler 210 of the transmitter 204. Output of the Y-junction coupler 280 is supplied to a wide output path/waveguide node 282 and a narrow output path/waveguide node 284 of the Y-junction coupler 280 which de-multiplexes the combined optical output from the transmitter 204. A first detector 292 can be employed to detect modulated data received from the wide output path/waveguide node 282, and a second detector 294 can be employed to detect modulated data received from the narrow output path/waveguide node 284. As will be illustrated and described below, both the transmitter 204 and the receiver 208 can utilize cascaded Y-junction couplers to increase the amount of data that is spatially multiplexed along the transmission path.

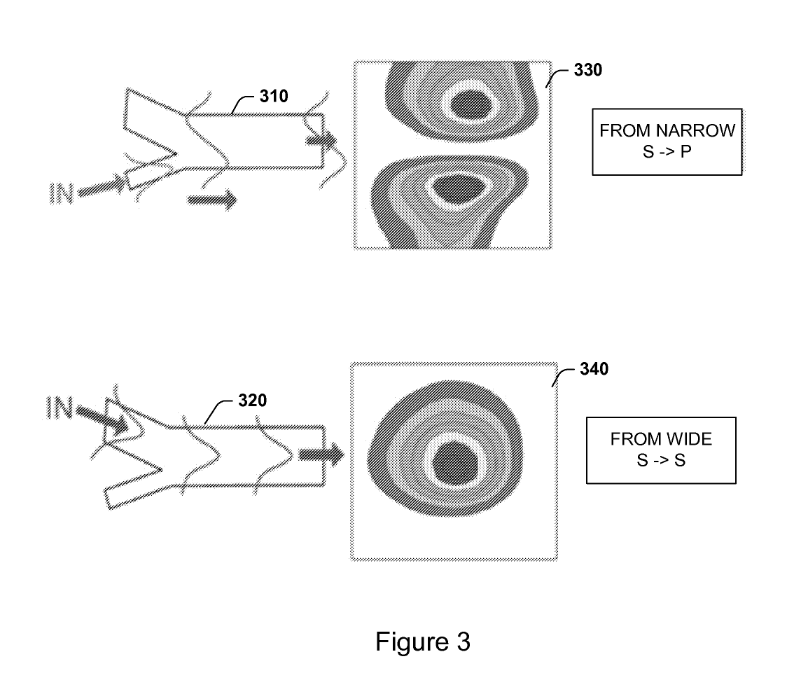

FIG. 3 illustrates example Y-junction couplers 310 and 320 that launch different propagation modes for optical signals. An adiabatic mode transformation is provided by the Y-junction couplers that are sometimes used in add-drop filters, for example. For instance, a nodeless main mode can be launched (referred to as an s-wave by analogy with quantum mechanics) towards the Y-junction 310 from a narrow waveguide node, and can be transformed into a mode with one node having two-lobes (referred to as a p-wave) as illustrated at 330. As used herein, an s-wave refers to a spherically symmetric wave (one concentric lobe) whereas a p-wave refers to a spherically asymmetric wave (two lobes). Similarly, an s-wave from the wide branch at 320 may remain a nodeless s-wave as illustrated at 340. It should be noted that the term “node” in the context of waveforms refers to quantum mechanical orbital properties, as opposed to “waveguide node” which refers to waveguide structure.

By cascading Y-junctions as will be illustrated and described in greater detail below, four s-modes can be launched. From the Y-junctions, two of those modes can be transformed into orthogonal horizontally oriented p-modes (also referred to as degenerate p-symmetry modes), while retaining the other two s modes. Further, one of the respective p-modes can be transformed into a d-wave mode with four nodal lines while one of the s-waves can be converted into a vertically oriented p-mode. Thus, four orthogonal modes can be launched (e.g., s, p-horizontal/p_{H} or px, p-vertical/p_{V} or py, d) propagating independently in a single waveguide. As will be illustrated and described below, four waveguides on a horizontal plane can be employed, where the output from each waveguide can be combined into two Y-junctions couplers (Y1 and Y2), and the roots of the Y-junction couplers can be combined into one multimode waveguide. In one example, rectangular waveguides can be employed, wherein polarization can be preserved, but with the possibility of mixing of px and py-modes in curved waveguides. To avoid complication, a diversity scheme may be used to read an average signal from the px and py modes respectively. Alternatively, one of the respective p-channels may simply be dropped altogether, for example. Various configurations for waveguides, Y-junction couplers, optical transmitters, optical receivers, and modulation schemes are illustrated and described below.

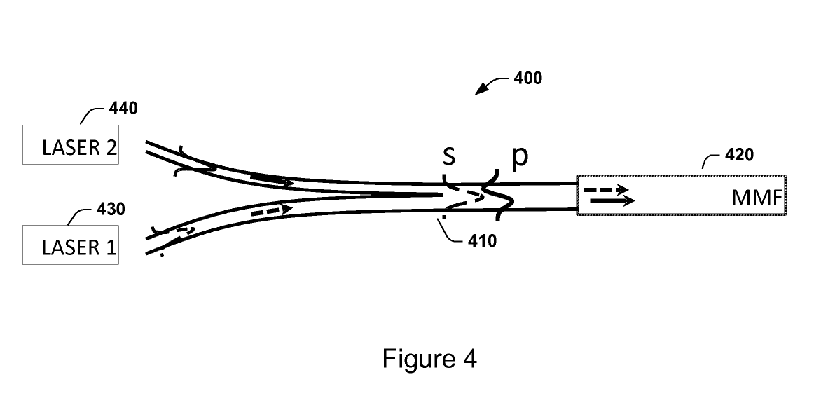

FIG. 4 illustrates an example optical transmitter system 400 utilizing a Y-junction coupler 410 to launch different propagation modes into a multimode waveguide (e.g., multimode fiber (MMF)) 420, where the multimode waveguide 420 may be a polarization preserving waveguide (PP WG), for example. As illustrated, lasers 430 and 440 can be employed to drive wide and narrow input paths/waveguide nodes, respectively, to the Y-junction coupler 410, where p and s modes generated from the respective narrow and wide input paths/waveguide nodes are supplied to the multimode waveguide 420. The Y-junction coupler 410 provides mode conversion (s->s and s->p) in the Y-junction coupler 410. That is, the s-wave launched in the narrow input path/waveguide node, propagates as a p-wave with one node into the wide input path/waveguide node. The combined signal (optical output waveform) may be directed into the multimode waveguide 420.

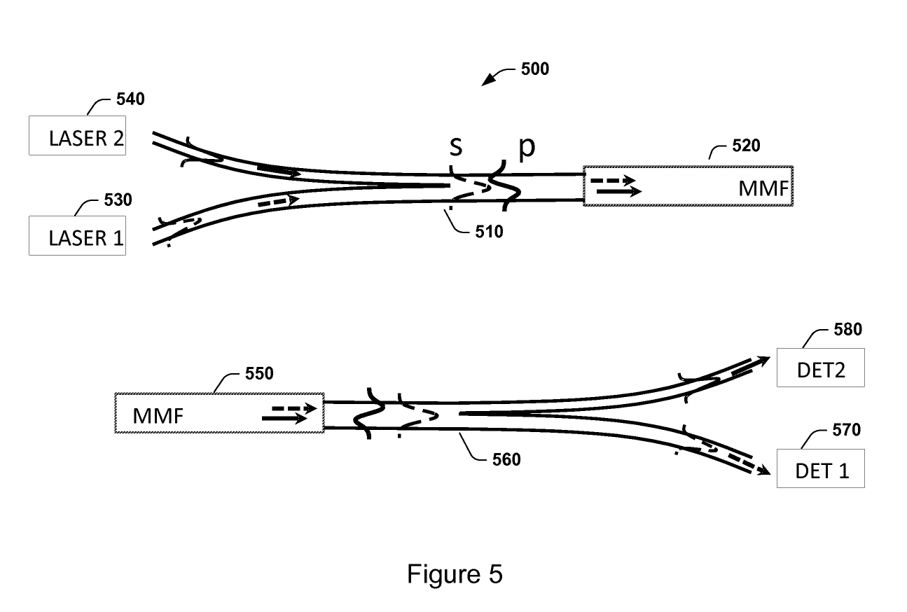

FIG. 5 illustrates an example optical transmitter and receiver system 500 that utilizes a Y-junction coupler 510 to launch different propagation modes into a multimode waveguide (e.g., MMF) 520 for spatially multiplexed transmission, and a multimode waveguide 550 and Y-junction coupler 560 for reception of multiplexed optical signals. As illustrated, lasers 530 and 540 can be employed to drive wide and narrow input paths/waveguide nodes, respectively, to the Y-junction coupler 510, where p and s modes generated from the respective narrow and wide input paths/waveguide nodes are supplied to the multimode waveguide 520. In one example, the Y-junction couplers 510 and 560 may be a set of adiabatic mode-converting couplers (AMCCs) employed to multiplex and de-multiplex the modes in the multimode waveguides 520 and 550, respectively, the multimode waveguides being two-mode waveguides/MMFs. In this example, two symmetric modes can be launched into multimode waveguide 550 that excite different symmetry modes in the multimode waveguide (even, odd), which then split into two detectors 570 and 580 as original even modes. The first input path/waveguide node to the Y-junction coupler 510 may be wider than the second input path/waveguide node to the Y-junction coupler 510. As a result, its mode can be coupled into the symmetric mode of the multimode (two-mode) waveguide 520, while the mode of the second input path/waveguide node can be coupled into the anti-symmetric mode of the multimode (two-mode) waveguide 520. The de-multiplexing provided by the Y-junction coupler 560 and associated wide and narrow output paths/waveguide nodes of the multimode (two-mode) waveguide 550 can operate in a similar manner. It should be noted, however, that the second mode in the two-mode waveguide 550 may rotate, and in accordance with certain examples, alternative configurations can be provided such as that described and illustrated below.

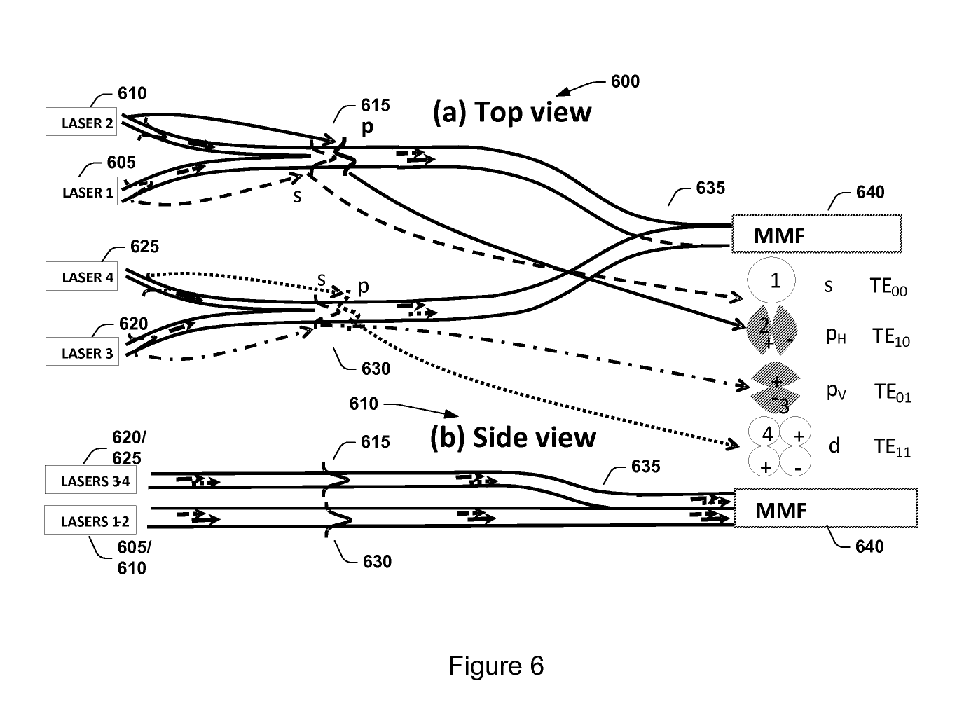

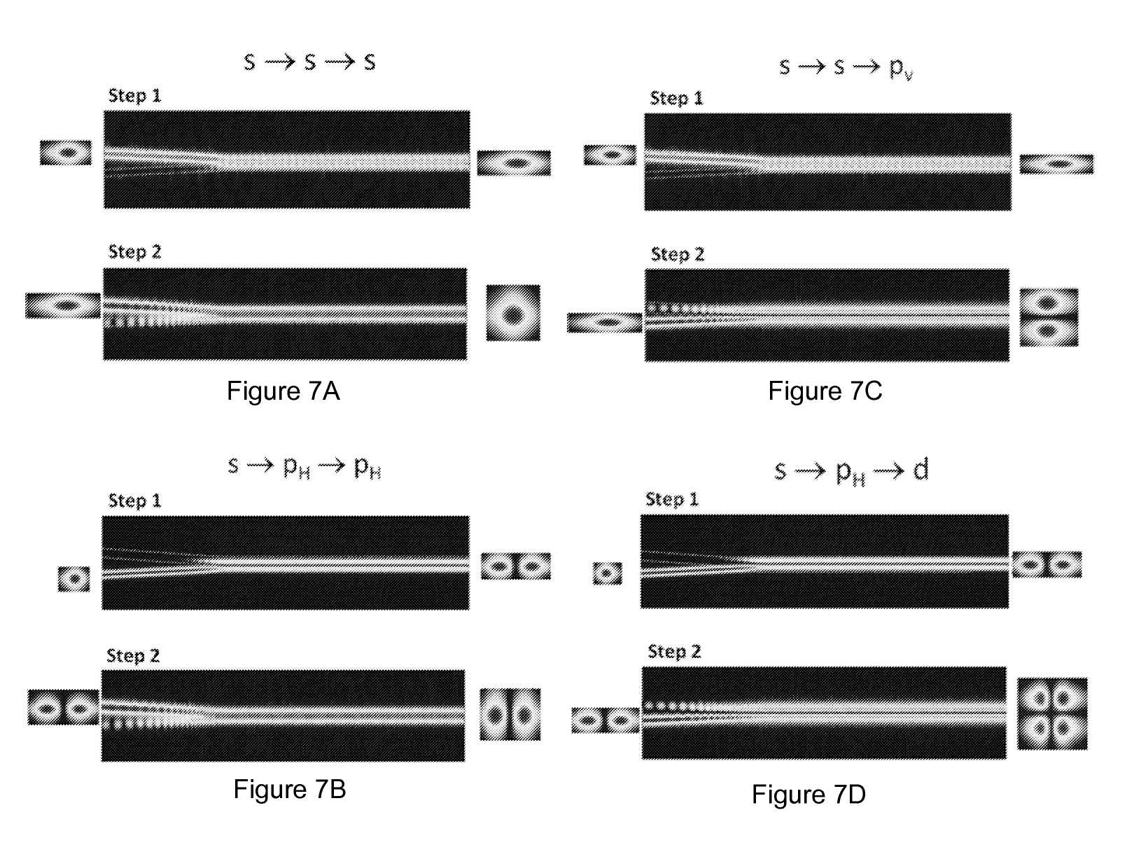

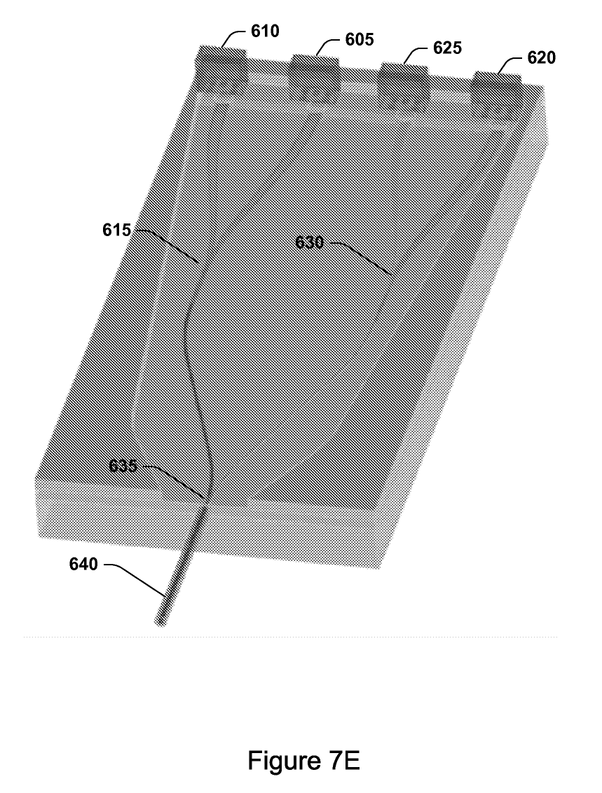

FIG. 6 illustrates a top view 600 and a side view 610 of a cascaded set of Y-junction couplers for generating spatially multiplexed optical signals. That is, Y-junction couplers 615 and 630 (driven by lasers (605, 610) and (620, 625), respectively) launch and mix optical signals from wide and narrow input paths/waveguide nodes into a subsequent Y-junction coupler 635 to produce four orthogonal modes that are directed to a multimode waveguide 640. Such a system can support substantially any modulation format (e.g., it can be OOK at 20-40 GHz or it can be FSK format using VCSELs). In this example, lasers (VCSELs) 620 and 625 are below lasers (VCSELs) 605 and 610 in vertical alignment (e.g., a 2×2 VCSEL array), where coupling can occur in two steps and four propagating modes can be generated in the multimode waveguide 640. However, some of the propagating modes may be degenerate and a diversity system can be employed as depicted in FIGS. 7A-7E and described below. The four orthogonal modes may include a first mode (s-wave mode/transverse electric mode 00(TE₀₀)) 1, a second mode (first degenerate p-symmetry mode, in this case, p_{H}/TE₀₁) 2, a third mode (second degenerate p-symmetry mode, in this case, p_{V}/TE₀₁) 3, and a fourth mode (d-wave mode/TE₁₁) 4. It should be noted that transverse modes may occur because of certain boundary conditions imposed on a wave by a waveguide, where TE modes refer to modes having no electric field in the direction of propagation.

FIGS. 7A-7E illustrate the aforementioned coupling with respect to the cascaded set of Y-junction couplers for generating spatially multiplexed optical signals of FIG. 6. FIG. 7A illustrates coupling of a first optical signal with a second optical signal as it propagates through Y-junction coupler 615, and coupling (along with the second optical signal) with third and fourth optical signals as it propagates through Y-junction coupler 635, i.e. step 1 (s→s) and step 2 (s→s), ultimately resulting in the first s-wave mode. FIG. 7B illustrates coupling of the second optical signal with the first optical signal as it propagates through Y-junction coupler 615, and coupling (along with the first optical signal) with the third and fourth optical signals as it propagates through Y-junction coupler 635, i.e., step 1 (s→p_{H}) and step 2 (p_{H}→p_{H}). FIG. 7C illustrates coupling of the third optical signal with the fourth optical signal as it propagates through Y-junction coupler 630, and coupling (along with the fourth optical signal) with the first and second optical signals as it propagates through Y-junction coupler 635, i.e., step 1 (s→s) and step 2 (s→p_{V}). FIG. 7D illustrates coupling of the fourth optical signal with the third optical signal as it propagates through Y-junction coupler 630, and coupling (along with the third optical signal) with the first and second optical signals as it propagates through Y-junction coupler 635, i.e., step 1 (s→p_{H}) and step 2 (p_{H}→d).

FIG. 7E illustrates a perspective view of the cascaded set of Y-junction couplers for generating spatially multiplexed optical signals of FIG. 6, including lasers (e.g., VCELs) 605, 610, 620, and 625 for driving the wide and narrow input paths/waveguide nodes to the Y-junction couplers 615 and 630, and subsequent Y-coupler 635 and multimode waveguide (MMF) 640. It should be noted that the “layout” illustrated in FIG. 7E may also apply to a receiver end, where instead of Y-junction couplers 615, 630, and 635 performing the multiplexing of optical signals, corresponding Y-junction couplers would be de-multiplexing multiplexed optical signals, and instead of lasers 605, 610, 620, and 625 driving the input paths/waveguide nodes, corresponding detectors would be receiving the de-multiplexed optical signals.

With respect to waveguide dimensions, the following describes example configurations that may be employed. In one example, a material with a refraction index n1=1.52, and cladding with an index n2=1.51 (e.g., Dow Corning® polymer type 1) can be employed. A wavelength of interest, λ=1.3 μm, for example can be considered, with a Dow Corning® polymer having the above indices for the core and the cladding. All upper waveguides can be 2.8 microns thick, for example (all waveguides supporting the Y-junction coupler 620). A first waveguide may be 12×2.8 microns at the Y-junction coupler 620, which supports two modes. The first waveguide may result from a merging of a 4-micron narrow input path/waveguide node and an 8-micron wide input path/waveguide node. Lower waveguides can be 3.6 microns thick (all waveguides supporting the Y-junction coupler 630). Thus, a second waveguide may be 12×3.6 microns at the Y-junction coupler 630, which results from a merging of a 4-micron narrow input path/waveguide node and an 8-micron wide input path/waveguide node, and also supports two modes. The first and second (upper and lower) waveguides may then merge into one 12×8 micron waveguide that supports four modes at the subsequent Y-junction coupler 640. This 12×8 micron waveguide then narrows into an 8×8 micron multimode waveguide 650 and couples into a transmission path (where less than 1 Km optical links can be directed into multimode fiber, since mixing there is small).

In an alternative example, a material with an n1=1.51 index core and an n2=1.50 index cladding (e.g., Dow Corning® type) may be utilized. The top waveguides can be 6 microns thick. The width of a first narrow waveguide node can be 6 microns and the width of a second wide waveguide node can be 10 microns. The first and second waveguide nodes may merge into 16×6 micron multimode waveguide at the Y-junction coupler 620 which supports two modes. The lower waveguides can be 8 microns thick. The width of first narrow waveguide node can be 6 microns, and the width of second wide waveguide node can be 10 microns, the first and second waveguide nodes merging into a 16×8 micron waveguide at Y-junction coupler 630 which supports two modes. Then, the two multimode waveguides resulting at the Y-junction couplers 620 and 630 may merge into one 16×14 micron multimode waveguide at Y-junction coupler 640 that supports four modes, which in turn narrows into a 14×14 micron waveguide 650, and couples into a transmission path (e.g., waveguide or optical fiber for links <1 Km). It should be noted that the angles between the aforementioned waveguides are approximately 1 degree. Thus, separation between the waveguides may be about 10 microns, i.e., the length may be 10 nm/1 degree in radians=10*50=500 um.

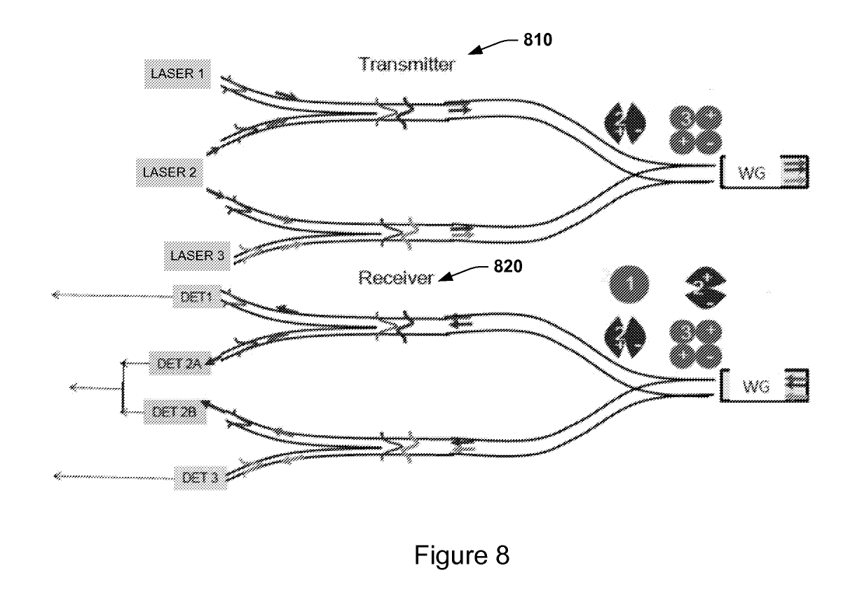

FIG. 8 illustrates an alternative configuration for a cascaded set of Y-junction couplers for generating and receiving spatially multiplexed optical signals. A transmitter portion 810 and receiver portion 820 can be configured with a diversity configuration to account for potential degenerate modes in the transmitter 810, which can launch two pairs of even-odd modes into top and bottom waveguides from three lasers, which are then aligned vertically. In this instance, two of the four modes may be degenerate, e.g., they have identical propagation constants in the waveguide. Therefore, unless a polarization preserving rectangular waveguide or a special optical fiber with some type of an elliptical cross-section is applied, these two modes can mix and de-multiplexing would then require some form of coherent detection which can increase cost. To mitigate the mixing issue (in order not to use coherent detection), 25% of the transmission capacity can be reduced wherein three channels, instead of four, are employed for detection. Thus, substantially identical signals may be launched into these two modes (e.g., from Laser 2), and then these two signals are combined at detectors into one signal.

As illustrated in FIG. 8, Laser 2 in the transmitter portion 810 can send a signal into the wider upper waveguide node (6×10 micron) and into narrower lower 8×6 micron waveguide node. Also, Laser 1 can send a signal into the upper 6×6 microns waveguide node, and Laser 3 may send a signal into the lower 8×10 micron waveguide now. Now, in accordance with the diversity configuration, the Laser 2 sends its signal in a superposition of two 01 modes, where in the waveguide (or fiber) these two modes mix, where the exact orientation of the mode at the receiver is not known. Therefore, two modes are detected with the same signal independently on detectors 2A and 2B in the receiver portion 820. These independently detected signals are then added to provide the diversity detection.

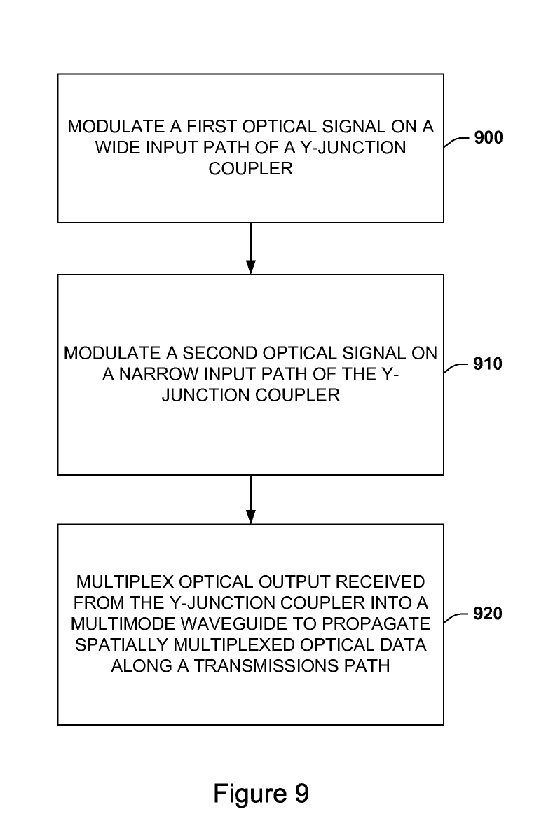

FIG. 9 illustrates a flowchart of an example method for generating and receiving spatially multiplexed optical signals. At 900, the method includes modulating a first optical signal on a wide input path of a Y-junction coupler. At 910, the method includes modulating a second optical signal on a narrow input path of the Y-junction coupler. At 920, the method includes multiplexing optical output received from the Y-junction coupler into a multimode waveguide to propagate spatially multiplexed optical data along a transmission path. In some examples, the method can also include cascading a second Y-junction coupler with the Y-junction coupler to increase a number of propagation modes in the spatially multiplexed optical data. This can also include configuring a receiver having a multimode waveguide, Y-junction coupler (or couplers) and a detector to de-multiplex the spatially multiplexed optical signal received from the transmission path.

The method of FIG. 9 can also be utilized with a system. The system can include a first Y-junction coupler having a wide input path and narrow input path to receive a first subset of modulated optical input signals. The system includes a second Y-junction coupler having a wide input path and narrow input path to receive a second subset of modulated optical input signals. This can include a third Y-junction coupler to combine output from the first and second Y-junction couplers and generate a combined optical output signal. The system can also include a multimode waveguide that receives the combined optical output signal from the third Y-junction coupler and generates a spatially multiplexed optical output signal along a transmission path. This can include modulating one input from the first Y-junction coupler and one input from the second Y-junction coupler with a single modulation source in order to mitigate effects of degeneration as noted previously. In another example, diversity detection can be provided in a receiver such as shown in the example receiver 820 of FIG. 8. The method of FIG. 9 can include detecting two signal modes from a common signal on two detectors in the receiver and combining the signal modes with the proper weightings to provide diversity detection in the receiver and mitigate issues of degenerate modes being launched in the transmitter.

Coherent detection allows for an increase in cumulative data rates of communication systems (especially in the case of short haul telecommunication systems). This may be accomplished by utilizing advanced modulation formats including, but not limited to, the aforementioned QPSK format, or M-quadrature amplitude modulation (M-QAM) format, a quantized QAM format, where M refers to the number of symbols in a modulation constellation that represents the possible symbols that may be selected by the M-QAM scheme. However, and as alluded to previously, coherent detection can introduce increased cost to an optical communications system. Such increased cost may come in the form of high quality components that are used to effectuate coherent detection, such as a narrow bandwidth laser used as a local oscillator at a receiver that is phase locked with a transmitted carrier.

In coherent optical communication systems, a weak input signal may be “mixed” with a strong wave (providing signal gain without optical amplification), where the resulting mixed product may then be detected. That is, a received signal is superimposed/aligned to be mode-matched using, e.g., a beam splitter or combiner, on a continuous wave optical field before reaching a detector (e.g., photodetector/photosensor, photodiode, etc.) The continuous wave optical field is often generated locally at a receiver portion of an optical communication system using the aforementioned narrow bandwidth laser, which is referred to as the local oscillator. Therefore, a modulated optical signal may be demodulated (detected) coherently using the local oscillator to obtain a modulating signal (containing information) that modulates a carrier signal.

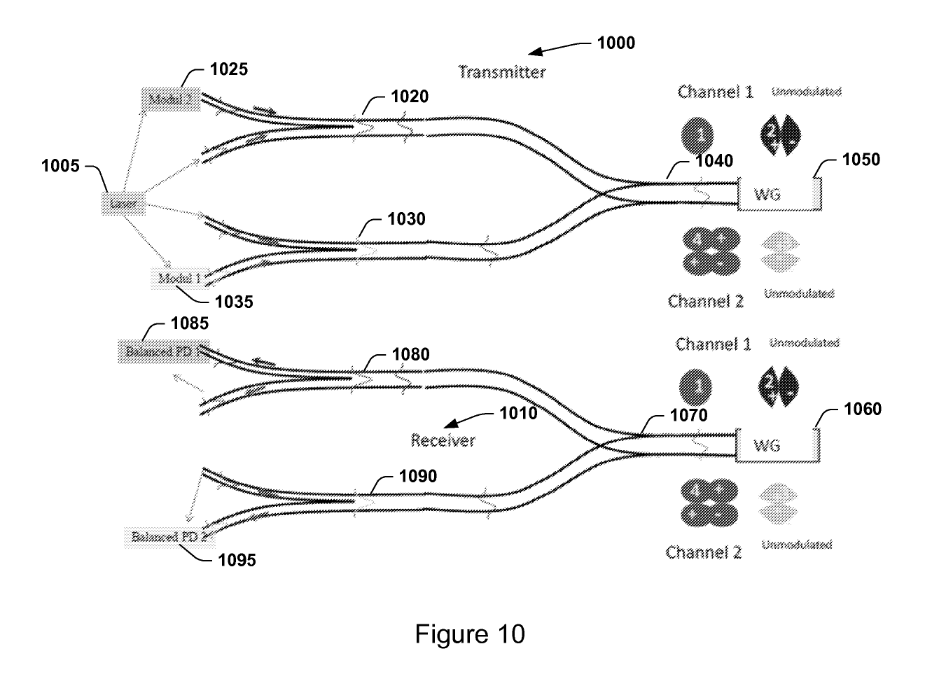

FIG. 10 illustrates a configuration of cascaded Y-junction couplers (such as that described in FIG. 6) for transmitting and receiving/multiplexing and de-multiplexing optical signals in accordance with another example. At the transmitter portion 1000, Y-junction couplers 1020 and 1030 launch and multiplex optical signals from wide and narrow input paths/waveguide nodes (driven by a single laser 1005) into a subsequent Y-junction coupler 1040 to produce four orthogonal modes that are directed to a multimode waveguide 1050. Such a system can support substantially any modulation format, including advanced modulation formats, where coupling can occur in two steps and four propagating modes can be generated in the multimode waveguide 1050.

The four orthogonal modes may include the following: a first mode (s-wave mode); a second mode (first degenerate p-symmetry mode); a third mode (second degenerate p-symmetry mode); and a fourth mode (d-wave mode). At the receiver portion 1010, the four orthogonal modes can be launched into multimode waveguide 1060. At Y-junction coupler 1070, the first and second modes are de-multiplexed/split from the third and fourth modes, and further splitting/de-multiplexing occurs at Y-junction coupler 1080 (first and second modes are de-multiplexed) and Y-junction coupler 1090 (third and fourth modes are de-multiplexed).

In the illustrated example, the optical signal(s) transmitted in the degenerate p-symmetry modes are unmodulated with orientations that are shifted by 90 degrees, while the second and fourth modes transmit coherently modulated optical signals, i.e., Channels 1 and 2, respectively, where Channels 1 and 2 may be modulated according to, for example, 16-QAM format. Thus, and instead of a local oscillator/narrow bandwidth laser being used at the receiver end to produce a continuous wave optical field for mixing with the modulated optical signals, the unmodulated optical signal(s) propagated in the second and third modes (degenerate p-symmetry modes) and the modulated optical signals received in the first and fourth modes are mixed for detection at balanced photodetectors (PD1 and PD2). It should be noted that instead of dedicating two degenerate p-symmetry modes for transmitting the unmodulated optical signal, only one p-wave mode may be dedicated to transmitting the unmodulated optical signal.

It should be noted that various examples may encompass scenarios where more or less (as alluded to previously) than four modes may be utilized to transmit/receive modulated and unmodulated optical signals in accordance with the systems and methods described herein for coherent detection. That is, various examples may be adapted to handle any number of a plurality of modulated optical signals for coherent detection, any number of stages/Y and cascaded Y-junctions without departing from the spirit and scope of the present disclosure. Additionally, it should be noted that the aforementioned modes may be utilized to carry any of the modulated/unmodulated optical signals. For example, the unmodulated signal, which described above, may be carried on degenerate p-wave modes, may instead be carried over the s-wave or the d-wave modes.

The unmodulated optical signal(s) (which may also be referred to as a “reference” optical signal) launched by the transmitter portion 1000 into the multimode waveguide 1050 through the degenerate p-symmetry modes may be represented by the following equation:

Eₚ=Ae^{j(ωt-φp)}

in which A refers to amplitude, ω refers to carrier frequency, and φ refers to phase of the optical signal.

The modulated optical signals that travel through the s and d-wave modes may be represented by the following equations:

Eₛ=[A_{sI}(t)+jA_{sQ}(t)]e^{j(ωt-φs)}

E_{d}=[A_{dI}(t)+jA_{dQ}(t)]e^{j(ωt-φd)}

in which A_{sI}(t) and A_{sQ}(t) and A_{d1}(t) and A_{dQ}(t) refer to the in-phase and quadrature amplitude components of the modulated optical signals sent through the s and d-wave modes, respectively, and may have values of (−3, −1, 1, 3) to obtain a 16 QAM modulated signal that may carry 4 bits per symbol.

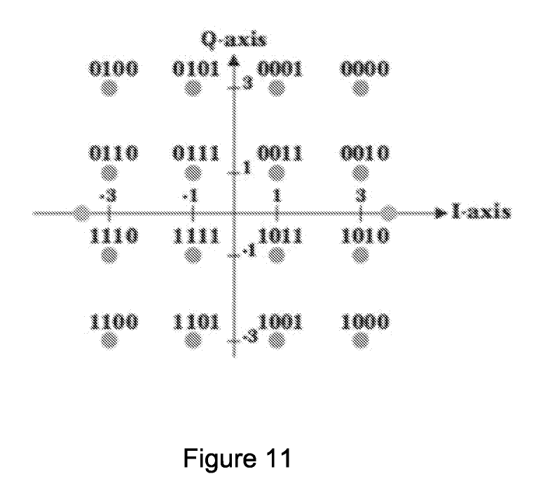

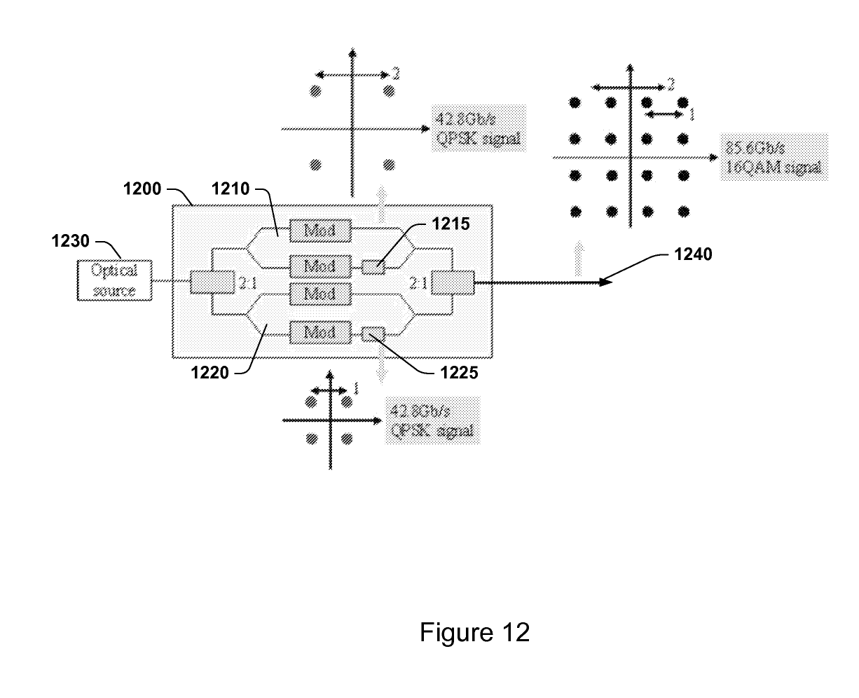

FIG. 11 illustrates the in-phase and quadrature-phase symbol mapping for such a 16 QAM constellation. To achieve advanced modulation (e.g., 16 QAM) as described above, a modulator may be used in accordance with various examples, which may utilize, e.g., two parallel Mach-Zehnder interferometric (MZI) modulators that are phase shifted by 90 degrees. FIG. 12 illustrates a modulator 1200 utilized in accordance with various examples that can handle QPSK, 8PSK, or 16 QAM modulation of an optical signal received from an optical source 1230, e.g., laser, which is split and sent to modulator 1200. The modulator 1200 further splits the optical signal for transmission through two MZI modulators 1210 and 1220. Each of the two MZI modulators 1210 and 1220 is made up of two modulating “arms” onto which the optical signal is sent, and to which a voltage is applied. A phase shift can be applied at 1215 and 1225. From the MZI modulator 1210, a first QPSK modulated signal may be a 42.8 Gb/s QPSK optical signal with a symbol distance of 2, while from the MZI modulator 1220, a second QPSK modulated signal may be a 42.8 Gb/s QPSK optical signal with a symbol distance of 1. The first and second QPSK modulated optical signals may be combined in a 2:1 combiner and output as an 85.6 Gb/s 16 QAM modulated optical signal.

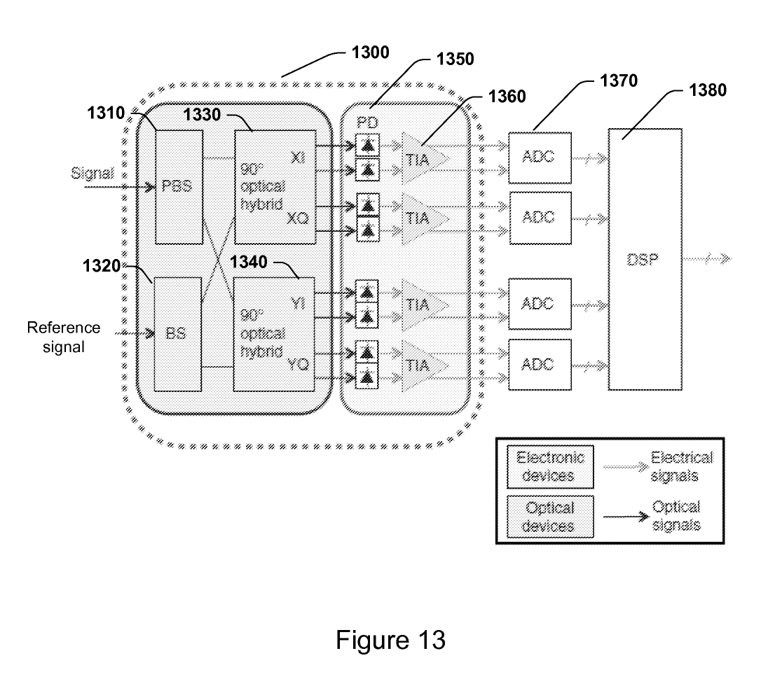

FIG. 13 illustrates a coherent receiver utilized in accordance with various examples. An optical receiver front end 1300 may include a polarization beam splitter 1310 that receives a modulated optical signal, and a beam splitter 1320 that receives a reference signal (which in accordance with various examples, may be an unmodulated optical signal transmitted in a degenerate p-wave mode of a multimode waveguide) for coherent detection as previously described. 90-degree optical hybrid mixers 1330 and 1340 are utilized to separate the modulated optical signal into orthogonal polarization components (X/Y polarized waves) and orthogonal phase components (in-phase and quadrature-phase components).

The aforementioned orthogonal polarization and phase components of the modulated optical signal are sent to photodetectors (i.e., photodiodes 1350) and transimpedance amplifiers (TIAs) 1360, the photodiodes 1350 and the TIAs 1360 making up an optical-electrical conversion section of the coherent optical receiver front end 1300. Once converted to electrical signals, the orthogonal polarization and phase components are sent to analog to digital converters 1370, and on to a digital signal processor 1380 that outputs a desired digital signal.

It should be noted that the polarization diversity achieved by utilizing the coherent receiver illustrated in FIG. 13 is not necessarily needed. Hence, in accordance with certain examples, only one half of the scheme may be utilized. In accordance with other examples, the entire scheme may be utilized to add capacity by a factor of two.

Referring back to FIG. 10, two modulators configured in the manner described above with respect to FIG. 12 (e.g., modulators 1025 and 1035) may be utilized to modulate two optical signals. Each of these two modulated optical signals is multiplexed (at each of Y-junction couplers 1020 and 1030) with an unmodulated optical signal. These signals are further multiplexed at Y-junction coupler 1040 and launched into the multimode waveguide 1050, where the two modulated optical signals are transmitted in the s and d-wave modes of the multimode waveguide 1050, while each unmodulated optical signal is transmitted in one of the degenerate p-wave modes of the multimode waveguide 1050. These signals are received at the multimode waveguide 1060 for de-multiplexing at the Y-junction coupler 1070, and further de-multiplexing at Y-junction couplers 1080 and 1090. As also previously described with respect to FIG. 13, coherent detection is performed, where the unmodulated optical signals received in the degenerate p-wave modes are utilized to coherently detect the modulated optical signals at balanced photodetectors 1085 and 1095.

When a modulated optical signal (e.g., the modulated optical signal transmitted on the s-wave mode) and a reference signal (i.e., one the unmodulated optical signals transmitted on one the degenerate p-wave modes) interfere, the following interference term results.

EₛEₚ=[A_{sI}(t)+jA_{sQ}(t)]e^{j(φs-φp)}

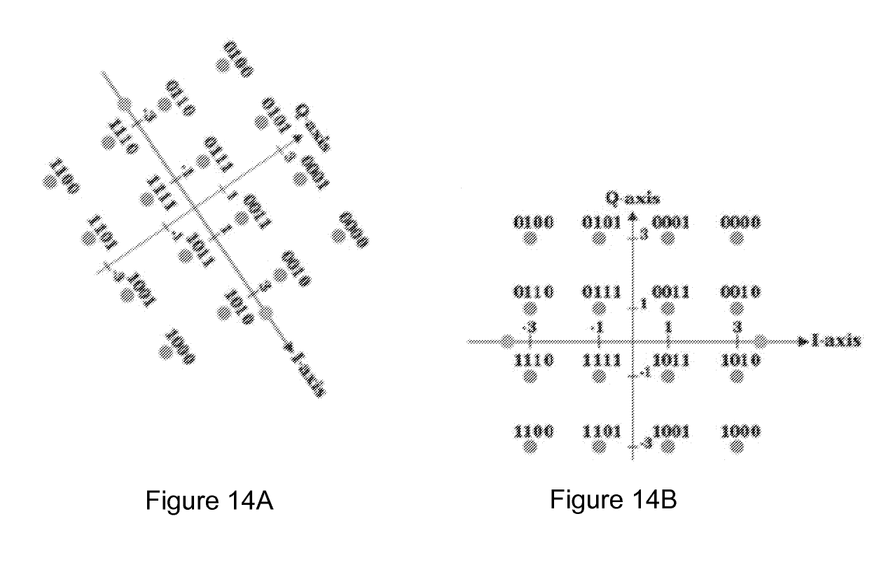

That is, and referring back to the 16 QAM constellation illustrated in FIG. 11, the bit grid “xyzw” may be rotated by an angle represented by (φs−φp), as illustrated in FIG. 14A. However, and as long as this angle remains constant (by assuring that a total optical path different between the s or d-wave mode and one of the degenerate p-wave modes is less than the coherence length (e.g., approximately 1-2 meters for a 100 MHz linewidth laser), the DSP 1280 is able to adjust the rotation by receiving a training signal. That is, the DSP 1380 is able to digitally rotate the bit grid “xyzw” back to its original orientation, as illustrated in FIG. 14B (and FIG. 11). In other words, the DSP 1380 is able to compensate for this rotation so long as the phase different between the modulated optical signal and the unmodulated (reference) signal is maintained.

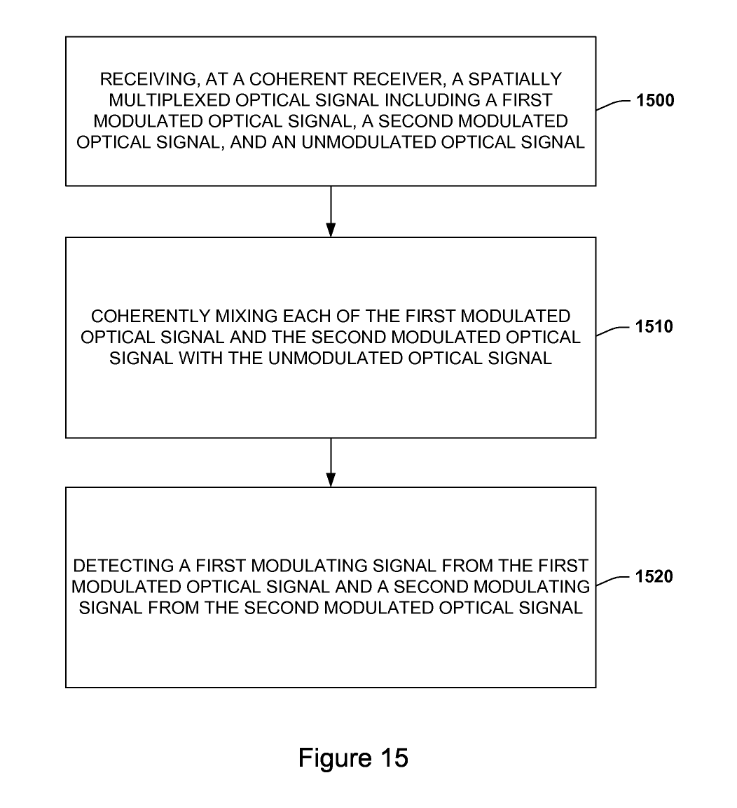

FIG. 15 illustrates example processes performed in accordance with various examples for receiving a spatially multiplexed optical signal and performing coherent detection. At 1500, the method includes receiving, at a coherent receiver, a spatially multiplexed optical signal including a first modulated optical signal, a second modulated optical signal, and an unmodulated optical signal. The spatially multiplexed optical signal may be received from a multimode waveguide, as described above, where the first modulated optical signal is received over an s-wave mode of the multimode waveguide, and the second modulated optical signal is received over a d-wave mode of the multimode waveguide. The unmodulated optical signal may be received over a p-wave mode or two, separate degenerate p-wave modes of the multimode waveguide. At 1510, the method further includes coherently mixing each of the first modulated optical signal and the second modulated optical signal with the unmodulated optical signal. At 1520, the method additionally includes detecting a first modulating signal from the first modulated optical signal and a second modulating signal from the second modulated optical signal.

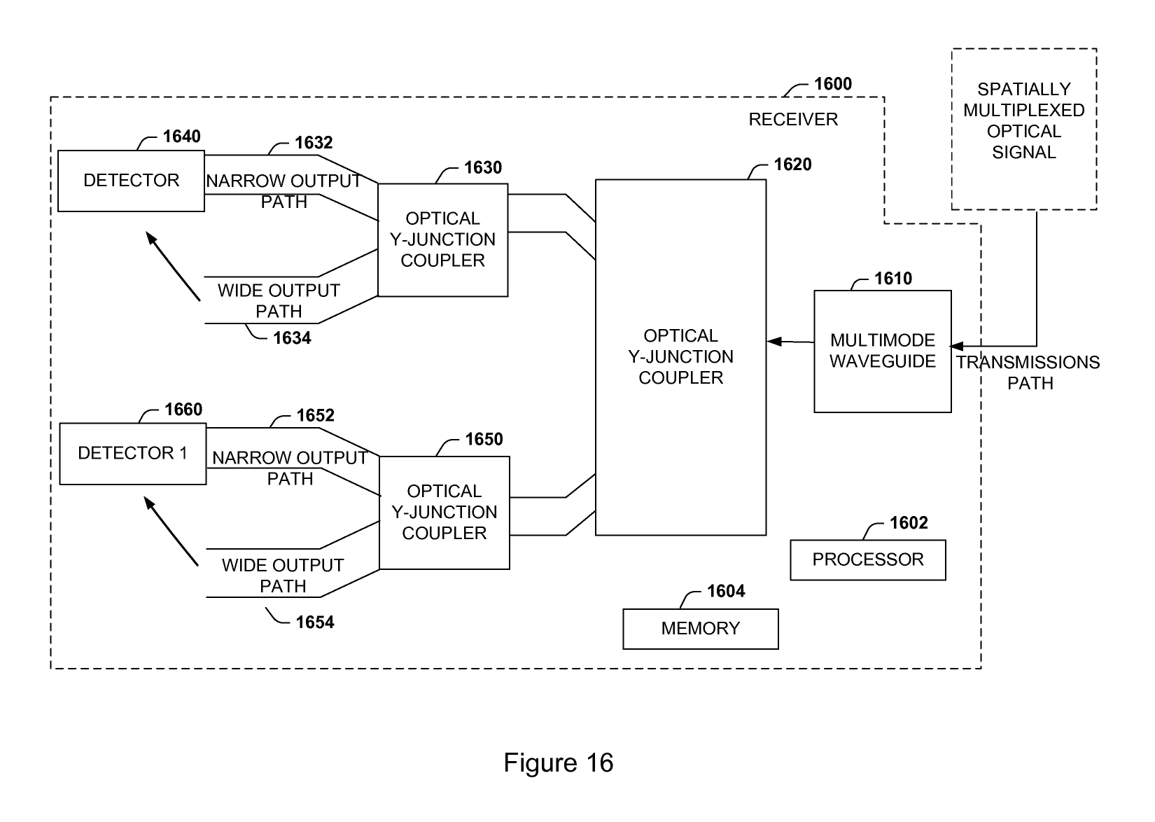

FIG. 16 illustrates a receiver 1600 for receiving a spatially multiplexed optical signal and coherently detecting modulated optical signals in accordance with various examples. Included in the receiver 1660 is a multimode waveguide 1610 into which four orthogonal modes can be launched (e.g., a first mode (s-wave mode); a second mode (first degenerate p-symmetry mode); a third mode (second degenerate p-symmetry mode); and a fourth mode (d-wave mode)). At Y-junction coupler 1620, the first and second modes are de-multiplexed/split from the third and fourth modes, and further splitting/de-multiplexing occurs at Y-junction coupler 1630 (first and second modes are de-multiplexed) and Y-junction coupler 1650 (third and fourth modes are de-multiplexed).

As previously described, the optical signal(s) transmitted in the degenerate p-symmetry modes are unmodulated with orientations that are shifted by 90 degrees, while the second and fourth modes transmit coherently modulated optical signals. The unmodulated optical signal(s) propagated in the second and third modes (degenerate p-symmetry modes) and the modulated optical signals received in the first and fourth modes are mixed for detection at detectors 1640 and 1660 (which can be balanced photodetectors). That is, the unmodulated optical signals received in the degenerate p-wave modes are utilized to coherently detect the modulated optical signals at detectors 1640 and 1660.

The receiver 1600 further includes a processor 1602 and a memory unit 1604, where the memory unit 1604 may store instructions and/or data that may be executed/operated on or by the processor 1602. For example, memory unit 1604 can store a computer program product that includes computer code for de-multiplexing, via the Y-junction coupler 1620, a spatially multiplexed optical signal, where the spatially multiplexed optical signal includes a first modulated optical signal component (in the s-wave mode) and a first unmodulated optical signal component (in the first degenerate p-symmetry mode) multiplexed with a second modulated optical signal component (in the d-wave mode) and a second unmodulated optical signal component (in the second degenerate p-symmetry mode). The computer program product stored on the memory unit 1604 may further include computer code for demultiplexing, via the Y-junction coupler 1630, the first modulated optical signal component and the first unmodulated optical signal component, and computer code for de-multiplexing, via the Y-junction coupler 1650, the second modulated optical signal component and the second unmodulated optical signal component. Further still, the computer program product stored on the memory unit 1604 for execution by the processor 1602 may include computer code for coherently mixing the first unmodulated optical signal with the first modulated optical signal to detect a first modulating signal at the detector 1640, as well as computer code for coherently mixing the second unmodulated optical signal with the second modulated optical signal to detect a second modulating signal at the detector 1660.

In accordance with various examples, two fully coherent channels may be realized without any need for a separate frequency and phase-locked local oscillator. For example, and utilizing 16 QAM modulation, as described above, 4 bits per symbol may be obtained. With two channels, one channel will have an 80 GBPs transmission rate even operating an optical source at 10 GHz.

While various examples have been described above in the context of certain modulation schemes and transmitter and receiver architectures, it should be understood that they have been presented by way of example only, and not of limitation. For example, the systems and methods described herein may be applied using alternative modulation schemes, transmitters, and receivers It should be further understood that more or less circuitry and/or components, whether multiplexers, waveguides, optical fiber, etc. may be implemented in long-haul or short-haul communication systems in accordance with various examples.

Likewise, the various diagrams may depict an example architectural or other configuration for the various examples, which is done to aid in understanding the features and functionality that can be included in examples. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various examples. Also, a multitude of different constituent module names other than those depicted herein can be applied to the various partitions. Additionally, with regard to flow diagrams, operational descriptions and method claims, the order in which the steps are presented herein shall not mandate that various examples be implemented to perform the recited functionality in the same order unless the context dictates otherwise.

It should be understood that the various features, aspects and/or functionality described in one or more of the individual examples are not limited in their applicability to the particular example with which they are described, but instead can be applied, alone or in various combinations, to one or more of the other examples, whether or not such examples are described and whether or not such features, aspects and/or functionality are presented as being a part of a described example. Thus, the breadth and scope of the present disclosure should not be limited by any of the above-described exemplary examples.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

Moreover, various examples described herein are described in the general context of method steps or processes, which may be implemented in one example by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more examples. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one example, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a transmitter to:
multiplex a plurality of modulated optical signals and an unmodulated optical signal; and
transmit the plurality of modulated optical signals and the unmodulated optical signal along a transmission path; and
a receiver to:
de-multiplex each of the plurality of modulated optical signals and the unmodulated optical signal; and
demodulate each of the plurality of modulated optical signals with the unmodulated optical signal to coherently detect a modulating signal from each of the plurality of modulated optical signals.

2. The system of claim 1, wherein the plurality of modulated optical signals includes a first modulated optical signal and a second modulated optical signal.

3. The system of claim 2, wherein the transmitter comprises:
a first Y-junction coupler for performing the multiplexing of the first modulated optical signal and the unmodulated optical signal;
a second Y-junction coupler for performing the multiplexing of the second modulated optical signal and the unmodulated optical signal; and
a third Y-junction coupler for multiplexing the first modulated optical signal multiplexed with the unmodulated optical signal and the second optical signal multiplexed with the unmodulated optical signal.

4. The system of claim 2, wherein the transmitter comprises a first multimode waveguide for outputting a spatially multiplexed optical output signal comprising the first modulated optical signal, the second modulated optical signal, and the unmodulated optical signal onto the transmission path.

5. The system of claim 4, wherein the receiver comprises a second multimode waveguide for receiving the spatially multiplexed optical output signal.

6. The system of claim 4, wherein the transmitting of each of the first modulated optical signal, the second modulated optical signal, and the unmodulated optical signal occurs on one of s-wave, d-wave, and degenerate p-wave modes of the first multimode waveguide.

7. The system of claim 2, wherein the receiver comprises:
a fourth Y-junction coupler for de-multiplexing the first modulated optical signal multiplexed with the unmodulated optical signal and the second optical signal multiplexed with the unmodulated optical signal;
a fifth Y-junction coupler for de-multiplexing the first modulated optical signal and the unmodulated optical signal; and
a sixth Y-junction coupler for de-multiplexing the second optical signal and the unmodulated optical signal.

8. The system of claim 2, wherein the first modulated optical signal and the second modulated optical signal are modulated using at least one of quadrature phase shift keying modulation, phase amplitude modulation, M-quadrature amplitude modulation, on-off keying modulation, and frequency shift keying modulation.

9. The system of claim 2 further comprising, a first balanced photodetector for coherently detecting the first modulating signal, and a second balanced photodetector for coherently detecting the second modulating signal.

10. A method comprising:
receiving, at a coherent receiver, a spatially multiplexed optical signal including a first modulated optical signal, a second modulated optical signal, and an unmodulated optical signal;
coherently mixing each of the first modulated optical signal and the second modulated optical signal with the unmodulated optical signal; and
detecting a first modulating signal from the first modulated optical signal and a second modulating signal from the second modulated optical signal.

11. The method of claim 9, wherein the spatially multiplexed optical signal is received from a multimode waveguide.

12. The method of claim 10, wherein the first modulated optical signal is received on an s-wave mode of the multimode waveguide, and the second modulated optical signal is received on a d-wave mode of the multimode waveguide.

13. The method of claim 10, wherein the unmodulated optical signal is received on one of either a p-wave mode of the multimode waveguide or on degenerate p-wave modes of the multimode waveguide.

14. A computer program product, embodied on a non-transitory computer-readable medium, comprising:
computer code for de-multiplexing, via a first Y-junction coupler, a spatially multiplexed optical signal, the spatially multiplexed optical signal including a first modulated optical signal component and a first unmodulated optical signal component multiplexed with a second modulated optical signal component and a second unmodulated optical signal component;
computer code for demultiplexing, via a second Y-junction coupler, the first modulated optical signal component and the first unmodulated optical signal component;
computer code for de-multiplexing, via a third Y-junction coupler, the second modulated optical signal component and the second unmodulated optical signal component; and
computer code for coherently mixing the first unmodulated optical signal with the first modulated optical signal to detect a first modulating signal; and
computer code for coherently mixing the second unmodulated optical signal with the second modulated optical signal to detect a second modulating signal.

15. The computer program product of claim 13, wherein the spatially multiplexed optical signal is received at a multimode waveguide having an s-wave mode for carrying the first modulated optical signal, a d-wave mode for carrying the second modulated optical signal, and two degenerate p-wave modes for carrying the unmodulated optical signal.
